(19) United States
(12) Patent Application Publication
(10) Pub. No.: US 2005/0091777 A1
(43) Pub. Date: May 5, 2005

(54) Adjustable frame for holding paint roller

(76) Inventor: Weiming Lu, Qingyuan City (CN)

Correspondence Address: CARSTENS YEE & CAHOON, LLP, P O BOX 802334, DALLAS, TX, 75380, US

(21) Appl. No.: 10/806,861

(22) Filed: Mar. 22, 2004

(30) Foreign Application Priority Data
Nov. 3, 2003 (CN) 2003201176198

(51) Int. Cl. B05C 17/02

(52) U.S. Cl. 15/230.11; 492/13; 492/19

(57) ABSTRACT

An adjustable frame for holding paint roller comprising: a pair of square arms, each of the square arms includes a distal part, a joint part, a pair of shafts at the ends of the distal parts, and a pair of racks which are opposite to each other and are respectively fixed at the ends of the joint parts; and a straight square tube which holds to the pair of joint parts and holds the pair of racks into its internal space, the pair of racks meshing with a gear wheel within the internal space of the square tube; a tee-joint which holds to the square tube, a pair of bearing holes through their walls holding up a bar to which the gear wheel is fixed, and one knob being fixed to one of two ends of the bar outside the wall of tee-joint. The present invention provides a holding-length adjustable frame that is capable of flexibly and tightly clamping and holding a variety of longitudinal sizes of paint rollers.

### BACKGROUND OF THE INVENTION

1. Field of the Invention

The present invention is related to frames for supporting rollers which have cylinder body and may roll, Particularly, the invention is related to a frame for supporting paint roller for coating pigment or paint on the wall surface of the building or furniture etc.

2. Technical Background

Usually a frame for supporting paint roller has a pair of arms with generally symmetrical bending shape, each of the arms has its distal part generally in parallel to the other and a shaft on the distal end to insert into hole on one of the two ends of the paint roller to support and clip it for rotation, each of the arms also has its joint part which is fixed to or into a T-shape joint with a handle, the pair of joint parts form a rigid holding length i.e. an unchangeable distance between the two ends of the pair of shafts, it means that one of the frame can clamps and holds only one longitudinal size of paint roller, that is to say, a prior art frame is not capable of fitting and holding a variety of longitudinal sizes of paint rollers, which resulted in inconvenience in the operation with various paint rollers.

### SUMMARY OF THE INVENTION

Having outlined the state of the prior art and its attendant shortages, the present invention's object is to provide an adjustable frame which is capable of adjusting the holding length of the frame to support and clip a wide variety of longitudinal sizes of paint rollers, moreover, the adjustment is flexible and the clipping force is strong enough.

The present invention provides an adjustable frame for holding paint roller, the frame comprising: a pair of square arms which have uniform bending-shape and are configured symmetrically, each of the square arms includes a distal part which is opposite to the other distal part, a joint part which is assembled opposite to and in line with the other joint part, a pair of shafts which are opposite to each other and are respectively fixed at the ends of the distal parts to insert into the hole(s) on the two ends of a paint roller, and a pair of racks which are opposite to each other and are respectively fixed at the ends of the joint parts; and a square tube which is straight, the square tube holds to the pair of joint parts respectively through its two ends and holds the pair of racks into its internal space accordingly, the pair of racks meshing with a gear wheel across the gear wheel within the internal space of the square tube; and a tee-joint which holds to the square tube, both the square tube and the tee-joint have a pair of bearing holes through their walls, the pair of bearing holes holding up a bar to which the gear wheel is fixed, and at least one knob being fixed to one of two ends of the bar outside the wall of tee-joint.

An adjustable frame for holding paint roller of the present invention allows operator to freely adjust the holding length formed by the joint parts of the square arms which are fitted into the square tube's internal space respectively through the square tube's two ends; by rotating the knob, through the bar and gear wheel, to move the racks and consequently to draw the distal parts away from or close to each other, operator may change the holding length of the frame—i.e. the distance between the two ends of the pair of shafts and fit the pair of shafts tightly against any paint roller of those with different lengths. In other words, the present invention provides a holding-length adjustable frame that is capable of flexibly and tightly clamping and holding a variety of longitudinal sizes of paint rollers.

### BRIEF DESCRIPTION OF THE DRAWINGS

FIG. 1 is a schematic front view of an adjustable frame for holding paint roller according to the present invention;

FIG. 2 is a section view of the adjustable frame including a tee-joint, a gear wheel, racks, joint parts and joint ends of square arms, square tube and one of fastening set; and

FIG. 3 is a partially section, side view of the adjustable frame with a handle.

### DETAILED DESCRIPTION OF THE PREFERRED EMBODIMENT

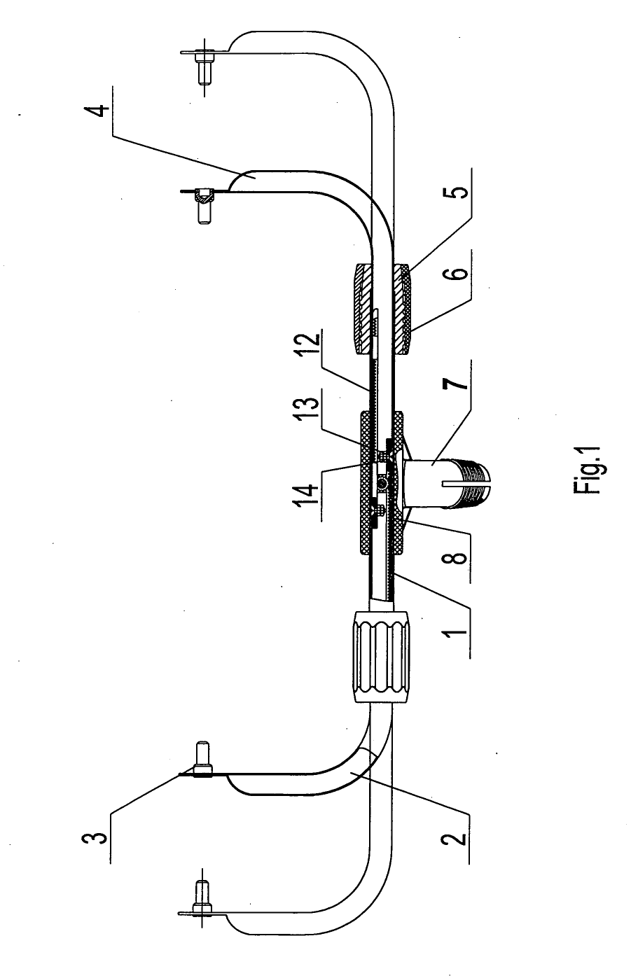

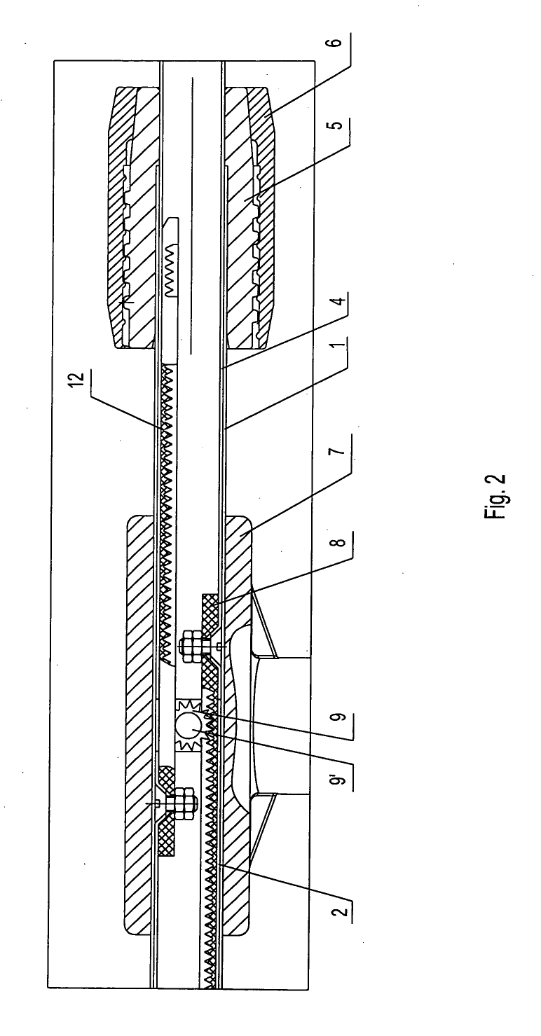

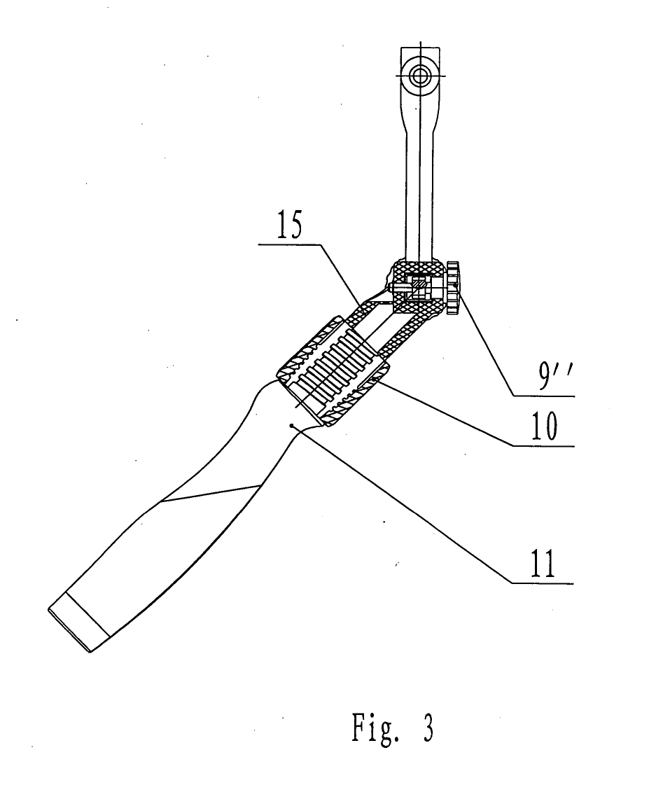

As it is shown in FIGS. 1, 2, and 3, an adjustable frame for holding paint roller comprising: a pair of square arms 2 and 4 which have uniform bending-shape, each of the square arms 2 and 4 includes a distal part which is in parallel to the other distal part, a joint part which is assembled opposite to and in line with the other joint part, a pair of shafts 3 which are opposite to and in line with each other and are respectively fixed at the ends of the distal parts to insert into the hole(s) on the two ends of a paint roller (not be shown), and a pair of racks 8 which are opposite to each other and are respectively fixed at the ends of the joint parts; and
a square tube 1 which is straight, the square tube 1 holds to the pair of joint parts 2 and 4 respectively through its two ends and holds the pair of racks 8 into its internal space accordingly, the pair of racks 8 meshing with a gear wheel 9 across the gear wheel 9 within the internal space of the square tube 1; and
a tee-joint 7 which holds to the square tube 1, both the square tube 2 and 4 and the tee-joint 7 have a pair of bearing holes through their walls, the pair of bearing holes holding up a bar 9′ to which the gear wheel 9 is fixed, and one knob 9″ being fixed to one of two ends of the bar 9′ outside the wall of tee-joint 7.

The racks 8 are fixed respectively at the ends of the joint parts with screw fasteners 13 and 14.

The adjustable frame also comprising: a pair of fastening sets which are configured respectively at the two ends of the square tube, each of the sets includes an inner pipe 5 which has male screw on its outer wall and an outer pipe 6 which has female screw on its inner wall cone-shaped, the inner pipe 5 holding to both the square tube 1 and the joint part of the square arm 2 or 4, the outer pipe 6 fitting the inner pipe 5 to enhance the holding force between the square tube 1 and the joint parts of 2 or 4.

The tee-joint 7 includes a screw socket 15 which has female screw on its inner wall to couple with a handle 11 and has male screw on its outer wall cone-shaped to couple with a screw tube 10 having female screw on its inner wall.

Before or after coating operation, operator may loose the outer pipe 6 from the inner pipe 5 by rotating it, then rotate the knob 9″ and consequently the gear wheel 9 to move racks 8 and 12 and to bring the pair of ends of shafts 3 away from or close to each other in order to adjust the holding distance between the pair of shafts 3. In the above adjustment, operator may fit tightly a new paint roller that has different length from the replaced on the frame, and then rotate the outer pipe 6 on the pipe 5 to tighten the inner pipe 5 for enhancing the coupling force between the joint parts of the square arms 2 and 4 and the square tube 1. Operator may also fix a handle 11 into the screw socket 15 and further tighten it with the screw tube 10.

1. An adjustable frame for holding paint roller, the frame comprising:
a pair of square arms which have uniform bending-shape, wherein each of the square arms includes a distal part which is opposite to the other distal part, a joint part which is assembled opposite to and in line with the other joint part, a pair of shafts which are opposite to each other and are respectively fixed at the ends of the distal parts to insert into the hole(s) on the two ends of a paint roller, and a pair of racks which are opposite to each other and are respectively fixed at the ends of the joint parts; and
a square tube which is straight, wherein the square tube holds to the pair of joint parts respectively through its two ends and holds the pair of racks into its internal space accordingly, the pair of racks meshing with a gear wheel across the gear wheel within the internal space of the square tube; and
a tee-joint which holds to the square tube, wherein both the square tube and the tee joint have a pair of bearing holes through their walls, the pair of bearing holes holding up a bar to which the gear wheel is fixed, and at least one knob being fixed to one of two ends of the bar outside the wall of tee-joint.

2. The adjustable frame of claim 1, wherein the racks are fixed respectively at the ends of the joint parts with screw fasteners.

3. The adjustable frame of claim 1, wherein the adjustable frame further comprising: a pair of fastening sets which are configured respectively at the two ends of the square tube, wherein each of the sets includes an inner pipe which has male screw on its outer wall and an outer pipe which has female screw on its inner wall cone-shaped, the inner pipe holding to both the square tube and the joint part of the square arm, the outer pipe fitting the inner pipe to enhance the square tube's force for holding to the joint parts.

4. The adjustable frame of claim 1, wherein the tee-joint includes a screw socket which has female screw on its inner wall to couple with a handle and has male screw on its outer wall cone-shaped to couple with a screw tube having female screw on its inner wall.
